(19) United States
(12) Patent Application Publication
(10) Pub. No.: US 2017/0323508 A1
(43) Pub. Date: Nov. 9, 2017

(54) Coin Storage and Display System

(71) Applicant: Elia Martinez, Avondale, AZ (US)

(72) Inventor: Elia Martinez, Avondale, AZ (US)

(21) Appl. No.: 15/585,952

(22) Filed: May 3, 2017

Related U.S. Application Data
(60) Provisional application No. 62/331,025, filed on May 3, 2016.

(51) Int. Cl. G07D 9/00; B65D 21/02; B65D 25/10; B65D 85/58

(52) U.S. Cl. CPC G07D 9/002; B65D 85/58; B65D 21/0209; B65D 25/10

(57) ABSTRACT

A coin holder apparatus preferably comprising a ring, at least one arm extending outward from the ring, and at least one retention monocle at a distal end of the at least one arm. The center ring preferably further comprises a plurality of buttons on a top surface and a plurality of recesses on a bottom surface. The retention monocle further comprises a lip extending inwardly from a bottom surface of an inner periphery, and a plurality of nubs spaced around said inner periphery to capture and hold a coin, or coin-like object in place.

### CROSS-REFERENCE TO RELATED APPLICATIONS

The present application is related to and claims priority from prior provisional application Ser. No. 62/331,025, filed May 3, 2016, entitled “HOLDER FOR COINS OR TOKENS”, the contents of all of which are incorporated herein by this reference and are not admitted to be prior art with respect to the present invention by the mention in this cross-reference section.

### BACKGROUND OF THE INVENTION

The present invention relates generally to providing a system and method for displaying, storing, cataloging, and indexing coin-like objects. More particularly this invention relates to providing a coin storage and display system designed to store, collect, display, and catalog coins and coin-like objects.

### BRIEF SUMMARY OF THE INVENTION

The present invention is a coin holder apparatus preferably comprising a ring, at least one arm extending outward from the ring, and at least one retention monocle at a distal end of the at least one arm. The retention monocle is preferably sized to accept a standard denomination coin and further comprises a plurality of nubs spaced around an inside periphery to capture and hold the coin in place around a coin's outside edge. The ring and arm allows a person to hold and manipulate the coin holder apparatus to view the coin in the retention monocle without touching the coin itself.

The coin holder apparatus is preferably part of a coin storage and display system comprising a plurality of coin holders spaced around a center ring. The center ring preferably further comprises a plurality of buttons on a top surface and a plurality of recesses on a bottom surface opposite the plurality of buttons. Preferably, the recesses are configured to accept the buttons when a coin storage and display system is placed on top of a second coin storage and display system thus allowing multiple coin storage and display systems to be stacked and aligned in various positions for viewing, indexing, and storage.

The coin storage and display system preferably further comprises a location and retrieval system such that a specific coin's position within a specific retention monocle can be indexed and cataloged for future reference. The location and retrieval system acts to identify where a specific coin is located within the coin storage and display system such that it can be retrieved at a later date.

The coin storage and display system preferably further comprises an identification notch for labeling. The identification notch is preferably an angled, flattened portion suitable for engraving, stamping, or other forms of affixing an identifying or indexing mark. The identification notch is preferably angled such that it can be quickly viewed from the top or side of the coin storage and display system. The identification notch can be located on the center ring or, alternately, the arm.

### BRIEF DESCRIPTION OF THE DRAWINGS

The particular objects and features of the invention as well as the advantages will become apparent from the following description taken in connection with the accompanying drawings in which:

FIG. 1 is a perspective view of a coin holder apparatus for a COIN STORAGE AND DISPLAY SYSTEM according to a preferred embodiment of the present invention.

FIG. 2 is a side cut-away view for a COIN STORAGE AND DISPLAY SYSTEM according to a preferred embodiment of the present invention.

FIG. 3 is a perspective view for a COIN STORAGE AND DISPLAY SYSTEM according to a preferred embodiment of the present invention.

FIG. 4 is a side detail view of the aligning buttons on the center ring for a COIN STORAGE AND DISPLAY SYSTEM according to a preferred embodiment of the present invention.

FIG. 5 is a top view for a COIN STORAGE AND DISPLAY SYSTEM according to the preferred embodiment of the present invention.

FIG. 6 is a top view for a COIN STORAGE AND DISPLAY SYSTEM according to an alternate embodiment of the present invention.

FIG. 7 is a perspective view of multiple COIN STORAGE AND DISPLAY SYSTEMS stacked for viewing and storage purposes according to the preferred embodiment of the present invention.

FIGS. 8A, 8B and 8C are perspective views of the COIN STORAGE AND DISPLAY SYSTEM placed within various commercial storage containers.

FIG. 9A is a perspective view of the circular flat platform of the COIN STORAGE AND DISPLAY SYSTEM according to the preferred embodiment of the present invention.

FIG. 9B is a perspective view of the circular flat platform placed above the COIN STORAGE AND DISPLAY SYSTEM within a commercial storage container according to the preferred embodiment of the present invention.

### DETAILED DESCRIPTION OF THE INVENTION

The following description of the preferred embodiments of the invention is intended to enable someone skilled in the art to make and use this invention, but is not intended to limit the invention to these preferred embodiments.

Now referring to the drawings, FIG. 1 shows the invention described herein as a coin holder apparatus 100 preferably comprising a ring 110, at least one arm 120 extending outward from the ring 110, and at least one retention monocle 130 at a distal end of said arm 120. The retention monocle 130 is preferably a circular band further comprising a plurality of nubs 132 spaced around an inside periphery 134. The plurality of nubs 132 extend outwardly from the inside periphery 134 of the retention monocle 130 and hold the coin in place within by the edges of the retention monocle without damaging either face of the coin.

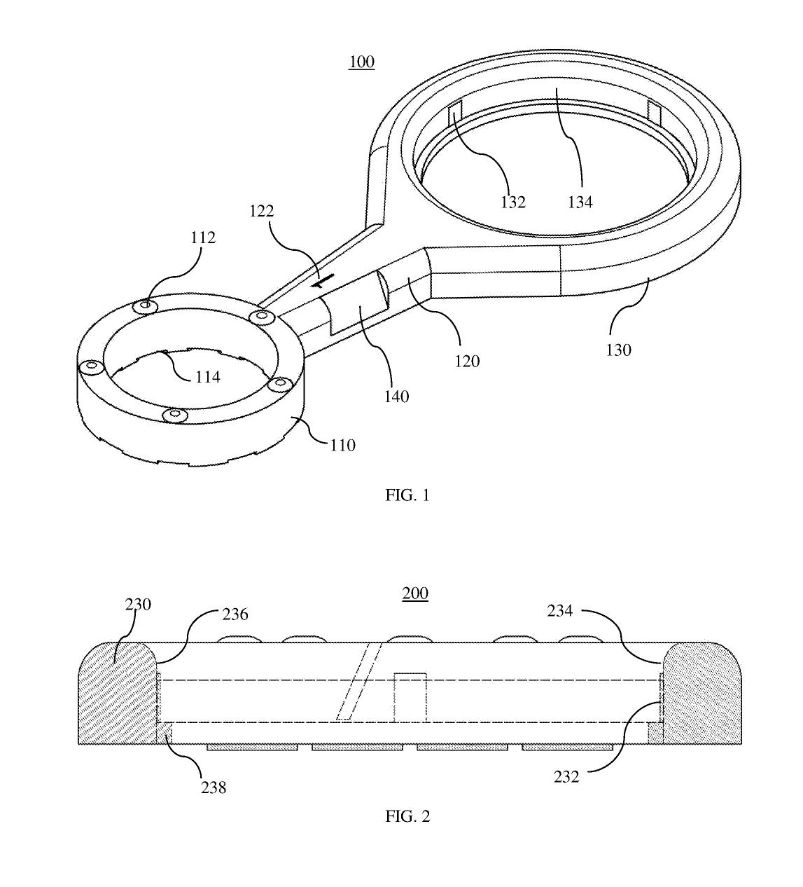

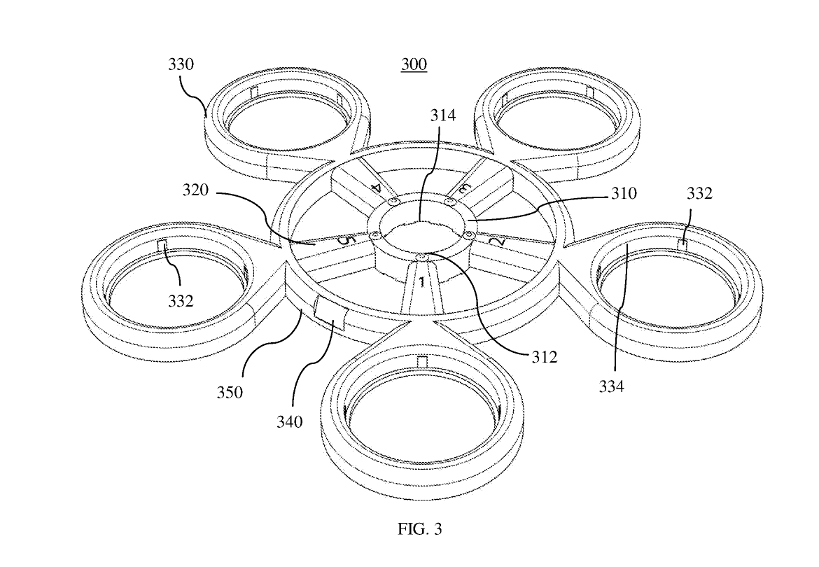

As further shown in FIG. 2, the coin holder apparatus 200 retention monocle 230 preferably comprises a tapered draft 236 on the inner periphery 234. The tapered draft of the inner periphery preferably guides the coin into the retention monocle where the plurality of nubs 232 captures and secures the coin within the retention monocle 230 due to an interference fit. The retention monocle preferably further comprises a lip 238 around a bottom surface of the inner periphery extending inward. The lip 238 provides a surface for the coin to sit on within the retention monocle 230 such that the coin does not push through the bottom of the retention monocle.

As further shown in FIG. 1, the arm 120 preferably extends from an outside periphery of the ring 110 to the outside periphery of the retention monocle 130. Preferably, the arm 120 is integral to both the ring 110 and the retention monocle 130. Alternately preferably, the arm is removably attached to both the ring and the retention monocle. Preferably, the arm 120 comprises a relatively flat top and bottom surface. Additionally, the top or bottom surface of the arm comprises a numerical or alphabetic character 122 stamped, etched, engraved, or allows a label to be affixed onto the material of the arm for identification and cataloging purposes.

As further shown in FIG. 1, the ring 110 is preferably a bore extending axially through the entire ring and sized to accept a standard commercial spindle. The ring 110 preferably further comprises a plurality of buttons 112 on a top surface and a plurality of recesses 114 on a bottom surface opposite the plurality of buttons. Preferably, the plurality of recesses 114 are configured to accept the plurality of buttons 112 when a coin holder apparatus is placed on top of a second coin holder apparatus. The plurality of buttons and recesses are arranged such that when multiple coin holders are stacked on top of each other, the buttons and recesses preferably position and align each coin holder in relation to the other coin holders. The standard commercial spindle may be used to aid in aligning multiple coin holders within a storage container.

As further shown in FIG. 1, the coin holder apparatus 100 preferably further comprises a notch 140 for identification. This identification notch 140 is preferably an angled flat surface preferably located on an outside edge of the arm 120. Alternately preferably, the identification notch 140 is located on an outside edge of the ring or an outside edge of the retention monocle 130. Preferably, the surface of the identification notch can be marked with a numerical or alphabetic character for indexing and cataloging purposes.

As shown in FIG. 3, a coin storage and display system 300 comprises a center ring 310, a plurality of arms 320 extending outwardly from the center ring 310, and a plurality of retention monocles 330 affixed to one or more of said arms 320, wherein said plurality of arms are spaced around said center ring 310, and wherein said plurality of retention monocles 330 further comprise a plurality of nubs 332 spaced around an inside periphery 334. The plurality of arms and plurality of retention monocles are as described above from the coin holder apparatus 100. The center ring 310 is the same as the ring described above as part of the coin holder apparatus, except that a plurality of arms extend outwardly from the center ring.

As further shown in FIG. 3, the coin storage and display system 300 preferably further comprises an outer wheel 350 connecting a distal end of the plurality of arms 320 to each other. The outer wheel 350 is preferably circular and circumscribes the coin storage and display system 300. The plurality of retention monocles 330 are attached to the distal end of the plurality of arms outside of the outer wheel 350. As with the coin holder apparatus described above, the coin storage and display system 300 preferably further comprises an identification notch 340. The identification notch 340 is preferably an angled, flattened portion suitable for engraving, stamping, or other forms of affixing an identifying or indexing mark. The identification notch is preferably located on the outer wheel 350 and angled such that it can be quickly viewed from the top or side of the coin storage and display system 300.

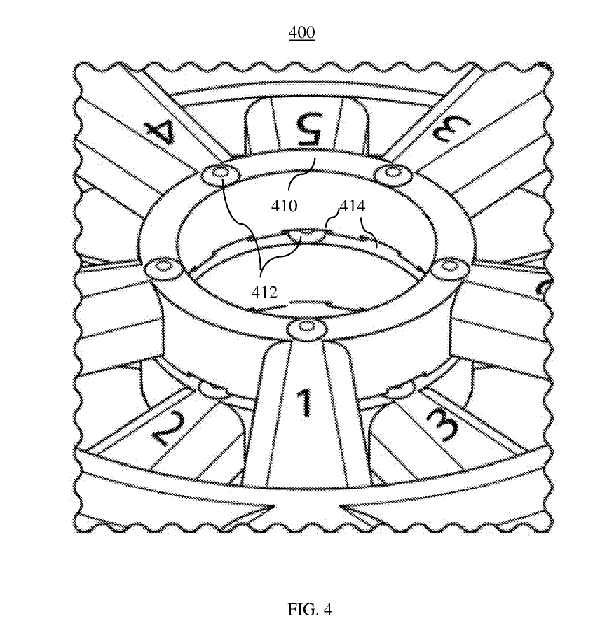

As shown in FIG. 4, the center ring 410 preferably further comprises a plurality of buttons 412 and a plurality of recesses 414, as described above with respect to the ring of the coin holder apparatus, which are designed to align multiple coin storage and display systems 400 that are stacked on top of each other. The plurality of buttons 412 and plurality of recesses 414 are preferably positioned such that when stacked, each coin storage and display system 400 may be in-line with the other, or off-set with the other depending on how the plurality of buttons and plurality of recesses are aligned.

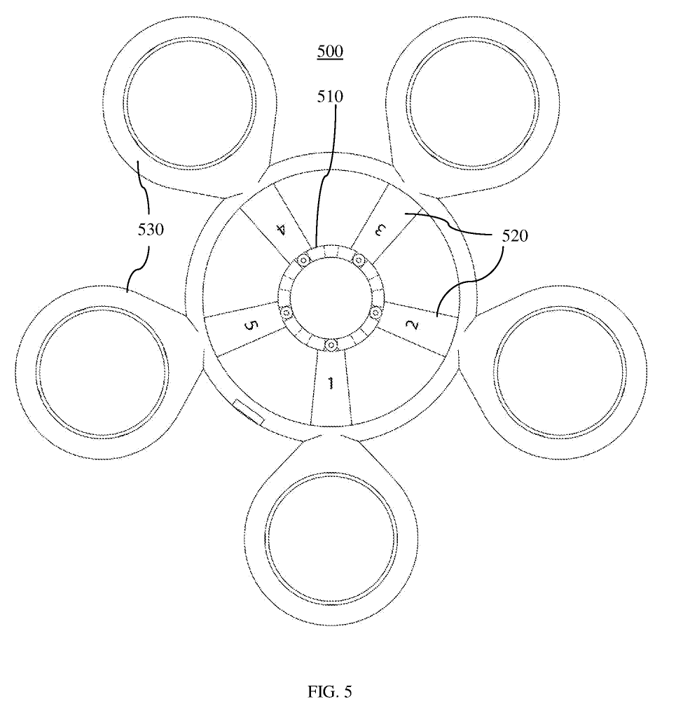

As shown in FIG. 5, the plurality of arms 520 are preferably oriented on the coin storage and display system 500 in a circular spoke-type pattern in relation to the center ring 510 wherein the outside edge of the plurality of retention monocles 530 form a consistent outside diameter. The plurality of retention monocles 530 are preferably affixed, or integral, to one or more of the plurality of arms 520 at a distal end. The plurality of retention monocles are preferably all sized to hold a coin of the same denomination, such as an quarter.

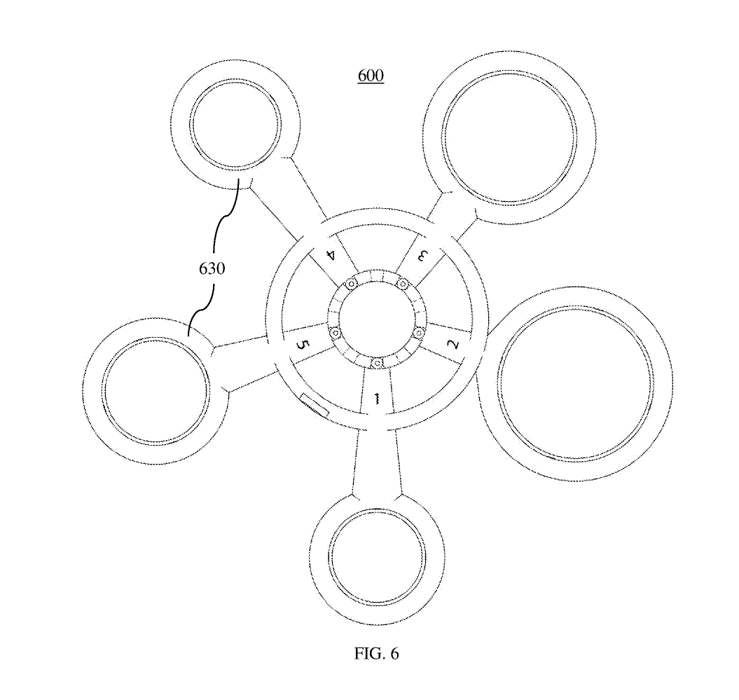

As shown in FIG. 6, an alternate embodiment of the coin storage and display system 600 comprises a plurality of retention monocles 630 sized to hold different sized, or denominations, coins. However, the outside edge of the plurality of retention monocles of different sizes still form a consistent outside diameter that is similar to the outside diameter of the embodiment with the same sized plurality of retention monocles.

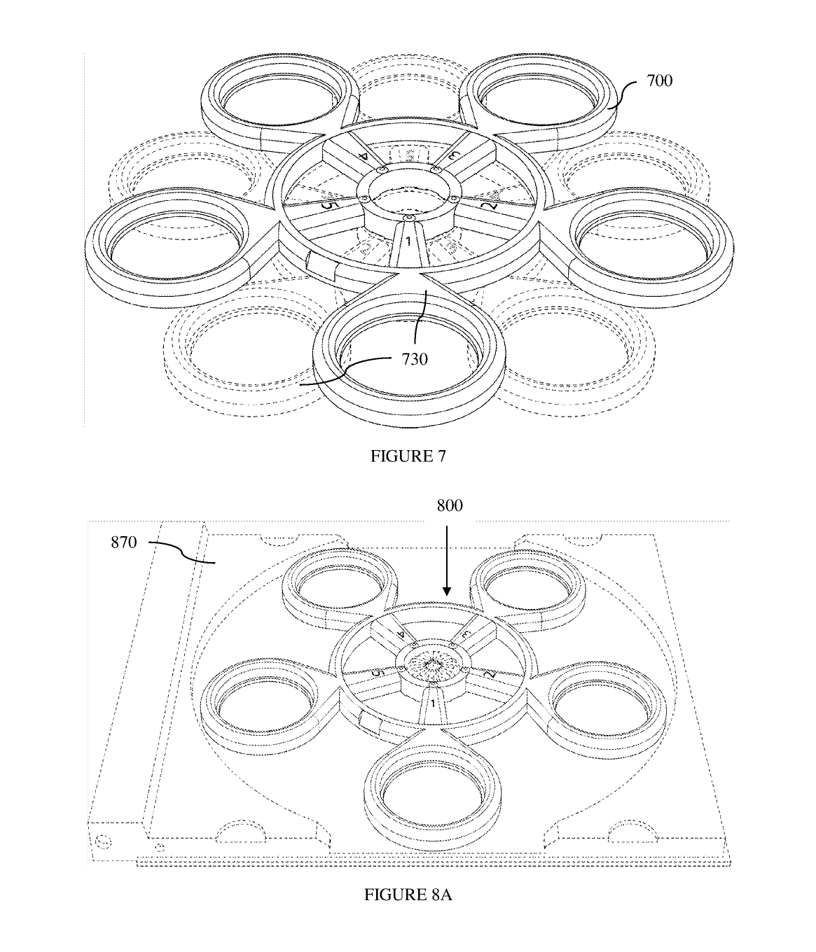

As shown in FIG. 7, when multiple coin storage and display systems 700 are stacked and aligned in an off-set position, a user or collector can view, and/or inventory, the coins within both of the coin storage and display systems 700. The coins, or coin-like objects, within the retention monocles 730 in a coin storage and display system on the bottom of the stack are visible between the coins within the retention monocles in a coin storage and display system above it.

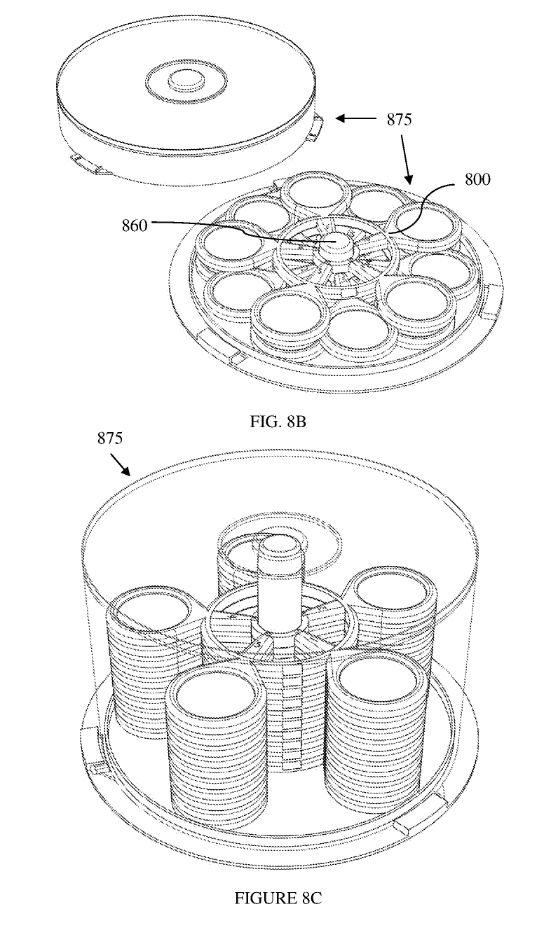

As shown in FIGS. 8A, 8B, and 8C, the coin storage and display system 800 allows for storage in a single commercial CD (compact disc) storage container 870 or a standard commercial spindle container 875 of various sizes. FIG. 8A shows a single coin storage and display system 800 placed within a single commercial CD storage container 870. The single commercial CD storage container is preferably labeled with a number, letter, or combination of numbers and letters to identify the coin storage and display system within the jewel case. Multiple single commercial CD storage containers 870 can be stored in typical commercial storage units. The outside of the commercial storage unit would preferably be labeled to identify which coin storage and display systems are within the commercial storage unit.

Additionally, FIGS. 8B and 8C shows how multiple coin storage and display systems 800 can be stacked within a standard commercial spindle storage container. When multiple coin storage and display systems are stored in this manner, the center ring 810 of the coin storage and display system is placed over the spindle 860. Thus, a user can stack as many coin storage and display systems within a standard commercial spindle storage container as fit onto the spindle.

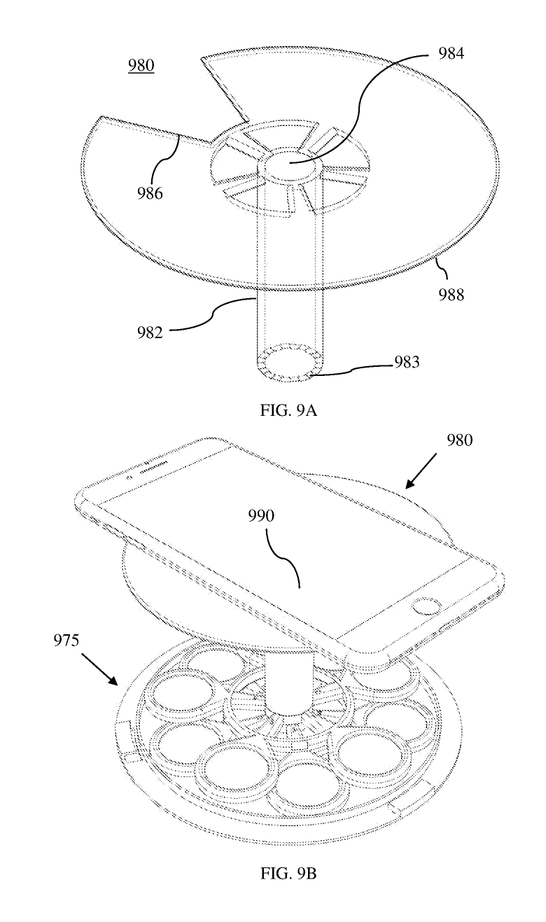

As shown in FIG. 9A, the coin storage and display system further comprises a circular flat platform 980 further comprising a tubular center bore 982 extending downward from a center 984 of said circular flat platform 980. The circular flat platform preferably further comprises a cutout 986 extending inward from an outer periphery 988 up to the tubular center bore, and comprising a portion of the circumference of the circular flat platform up to 50%. The tubular center bore 982 is sized to fit over a commercial spindle within a commercial spindle storage container 975 such that the circular flat platform is placed on the commercial spindle on top of a coin storage and display system as shown in FIG. 9B. The tubular center bore preferably further comprises a plurality of recesses 983 on a bottom surface that interacts with the plurality of buttons on the coin storage and display system center ring. As further shown in FIG. 9B, once in place, a user can use the circular flat platform 980 to place a mobile device 990 on an upper surface over the cutout to take a photo of the coins within the retention monocles below it.

A method for storing, displaying, and indexing coins, the method comprising the steps of: inserting a coin into a coin storage and display system, further comprising a center ring; a plurality of arms extending outwardly from said center ring; and a plurality of retention monocles affixed to one or more of said arms; identifying a location of said coin by marking said coin storage and display system; and cataloging said location of said coin in a corresponding document.

The method preferably further comprises the additional step of placing the coin storage and display system in a storage container. The storage container is preferably a standard commercial CD (compact disc) storage container. The standard commercial CD storage container can then be labeled such that when storing multiple storage containers comprising multiple coin storage and display systems within each storage container, a user or collector may easily keep track of where each coin is located, both within a specific coin storage and display system and within a specific standard commercial CD storage container. However, the storage container may be any type of storage container designed to house the coin storage and display system.

Preferably, the outer diameter of the coin storage and display system is constant such that the coin storage and display system can be stored in various commercial compact disc storage containers. Whether the plurality of retention monocles are the same within a coin storage and display system or are made up of different sizes, the outer diameter is the same.

The method preferably further comprises the additional step of indexing the storage container with specific coin storage and display systems stored within. The indexing step preferably includes marking an outside surface of the storage container in a manner as to identify the specific coin storage and display systems within the storage container such that a user or collector can easily determine the location of the coins.

I claim:

1. A coin holder apparatus comprising:
a ring;
at least one arm extending outward from said ring; and
at least one retention monocle at a distal end of said arm.

2. The coin holder apparatus of claim 1, further comprising a plurality of buttons extending upward from a top surface of said ring.

3. The coin holder apparatus of claim 2, further comprising a plurality of recesses located on a bottom surface of said ring, wherein said plurality of recesses are sized to accept said plurality of buttons when multiple coin holders are stacked on top of one another.

4. The coin holder apparatus of claim 1, wherein said retention monocle further comprises a lip extending inward from a bottom surface of an inner periphery; and
a plurality of nubs spaced around said inner periphery.

5. The coin holder apparatus of claim 4, wherein said retention monocle is sized to securely hold a standard denomination coin object.

6. The coin holder apparatus of claim 1, wherein said coin holder apparatus further comprises an identification notch.

7. The coin holder apparatus of claim 1, wherein said ring is sized to fit over a standard commercial spindle.

8. A coin storage and display system comprising:
a center ring;
a plurality of arms extending outwardly from said center ring; and
wherein said plurality of arms are spaced around said center ring.

9. The coin storage and display system of claim 8, further comprising a plurality of buttons extending upward from a top surface of said center ring.

10. The coin storage and display system of claim 9, further comprising a plurality of recesses located on a bottom surface of said center ring, wherein said plurality of recesses are sized to accept said button when multiple coin storage and display systems are stacked on top of one another.

11. The coin storage and display system of claim 8, wherein said retention monocle further comprises a lip extending inward from a bottom surface of an inner periphery; and
a plurality of nubs spaced around said inner periphery

12. The coin storage and display system of claim 11, wherein said retention monocle is sized to securely hold a standard denomination coin.

13. The coin storage and display system of claim 8, further comprising an identification notch.

14. The coin storage and display system of claim 13, wherein said identification notch is located on an outer wheel circumscribing a distal end of said plurality of arms.

15. The coin storage and display system of claim 8, wherein said center ring is sized to fit over a standard commercial spindle.

16. The coin storage and display system of claim 8, further comprising a circular flat platform further comprising a tubular center bore extending downward from a bottom surface of said circular flat platform.

17. The coin storage and display system of claim 16, wherein said circular flat platform further comprises a cutout extending inward from an outer periphery.

18. A method for storing, displaying, and cataloging coins, the method comprising the steps of:
inserting a coin into a coin storage and display system, further comprising a center ring, a plurality of arms extending outwardly from said center ring, and a plurality of retention monocles affixed to one or more distal ends of said arms;
identifying a location of said coin by marking said coin storage and display system; and
cataloging said location of said coin in a corresponding document.

19. The method of claim 18, further comprising the step of:
placing said coin storage and display system in a storage container.

20. The method of claim 19, further comprising the step of:
indexing said storage container with specific coin storage and display systems stored within.
